(19) United States
(12) Patent Application Publication
(10) Pub. No.: US 2014/0224904 A1
(43) Pub. Date: Aug. 14, 2014

(54) Foaming Nozzle

(71) Applicant: The Fountainhead Group, Inc., New York Mills, NY (US)

(72) Inventor: Mario J. Restive, Frankfort, NY (US)

(73) Assignee: The Fountainhead Group, Inc., New York Mills, NY (US)

(21) Appl. No.: 14/178,926

(22) Filed: Feb. 12, 2014

Related U.S. Application Data
(63) Continuation of application No. 29/445,471, filed on Feb. 12, 2013, now Pat. No. D702809.
(60) Provisional application No. 61/763,618, filed on Feb. 12, 2013.

(51) Int. Cl. B05B 1/14

(52) U.S. Cl. CPC B05B 1/14
USPC 239/590.3

(57) ABSTRACT

The present invention provides a foaming nozzle assembly for use with a sprayer. The foaming nozzle includes a nozzle head, a mesh screen, a screen retainer that securely connects the mesh screen to the nozzle head, a nozzle, and a cap nut that interconnects the assembly to a sprayer and retains the nozzle in stable position within the nozzle head and in fluid communication with the liquid in sprayer. The front end of the nozzle head is curved and the mesh screen and screen retainer are correspondingly shaped to create an arcuate spray distribution mechanism. The liquid from the sprayer is dispersed at high velocity by the nozzle towards the mesh screen. Upon impacting the mesh screen, the liquid foams as it exits the assembly.

### CROSS-REFERENCE TO RELATED APPLICATION

The present application relates and claims priority to (1) U.S. Provisional Patent Application, Ser. No. 61/763,618, filed Feb. 12, 2013, and (2) U.S. Design Pat. Application Ser. No. 29/445,471, filed Feb. 12, 2013, now allowed, the entirety of each being hereby incorporated by reference.

### BACKGROUND OF THE INVENTION

The present invention generally relates to nozzles for use on sprayers, such as insecticide, herbicide, cleaning fluids, disinfectants and pesticide sprayers, and more particularly to foaming nozzles.

### SUMMARY OF THE INVENTION

In accordance with the foregoing objects and advantages, the present invention provides a foaming nozzle assembly for use with a sprayer, comprising a nozzle head, a mesh screen, a screen retainer that securely connects the mesh screen to the nozzle head, a nozzle, and a cap nut that interconnects the assembly to a sprayer and retains the nozzle in stable position within the nozzle head and in fluid communication with the liquid in sprayer. The front end of the nozzle head is curved and the mesh screen and screen retainer are correspondingly shaped to create an arcuate spray distribution mechanism. The liquid from the sprayer is dispersed at high velocity by the nozzle towards the mesh screen. Upon impacting the mesh screen, the liquid foams as it exits the assembly.

The curvature of the mesh screen (and retainer) is symmetrical and bowed inwardly at a predetermined radius. The curved nature of the screen increases the surface area over which the liquid is dispersed and also increases the spray path over a radius that is equal to the radius of curvature. The fluid exiting the nozzle has a point source that creates the fan pattern. The fan pattern creates radial streams of fluid in a specific velocity range that generates the heavy foam when it hits the screen mesh. The screen mesh fits to a radius that is normal to the radial streams of the spray pattern. If the screen is not normal to the radial stream the foam will not carry any distance after it hits the screen and will bunch on the screen. The radial distance from the source point to the screen mesh is a critical distance needed to create a heavy foam. The mesh size which consists of both wire diameter and spacing also controls the consistency of the foam created.

The ranges of the controlling parameters:
1) Screen angle relative to the fluid stream; 90 deg+−5 deg
2) Flow rate: 0.15-0.35 gpm
3) Distance from source point to screen: 0.90″ to 1.10″
4) Fan angle 50-100 deg
5) Mesh #50

### BRIEF DESCRIPTION OF THE DRAWINGS

The present invention will be more fully understood and appreciated by reading the following Detailed Description in conjunction with the accompanying drawings, in which:

FIG. 1 is an exploded perspective view of the present invention;

FIG. 2 is a perspective view thereof;

FIG. 3 is a rearward oriented perspective view thereof;

FIG. 4 is a rear elevation view thereof;

FIG. 5 is a cross-sectional view taken along line 5-5 of FIG. 4;

FIG. 6 is a cross-sectional view taken along line 6-6 of FIG. 4;

FIG. 7 is a top plan view thereof;

FIG. 8 is a side elevation view thereof; and

FIG. 9 is a front elevation view thereof.

### DETAILED DESCRIPTION

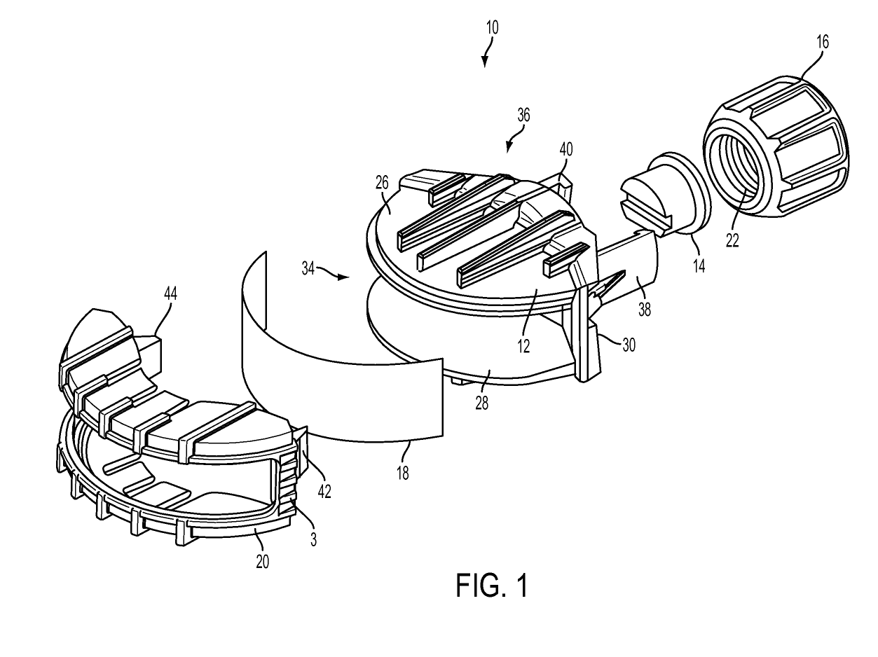

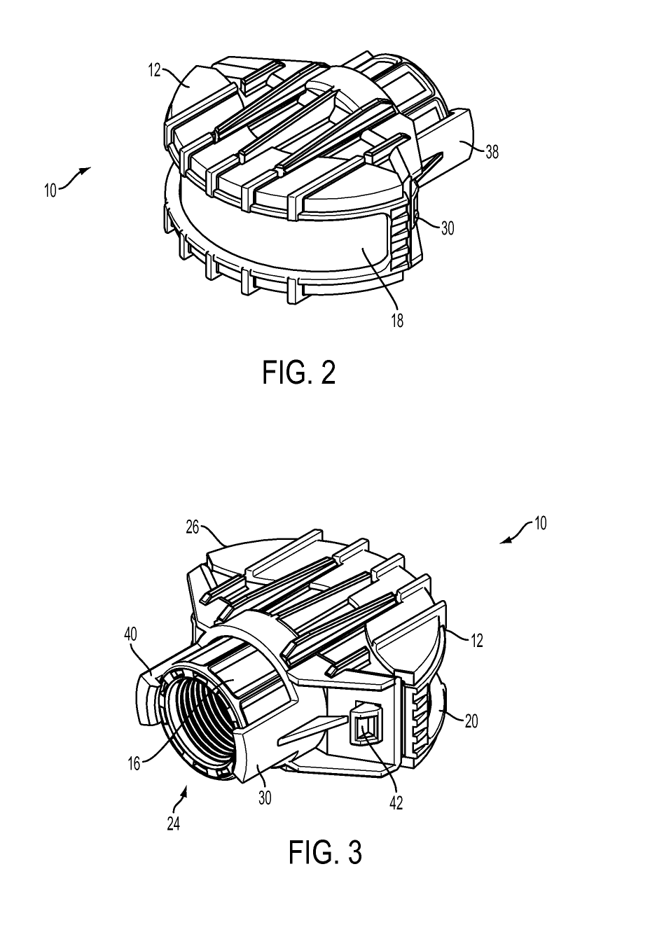

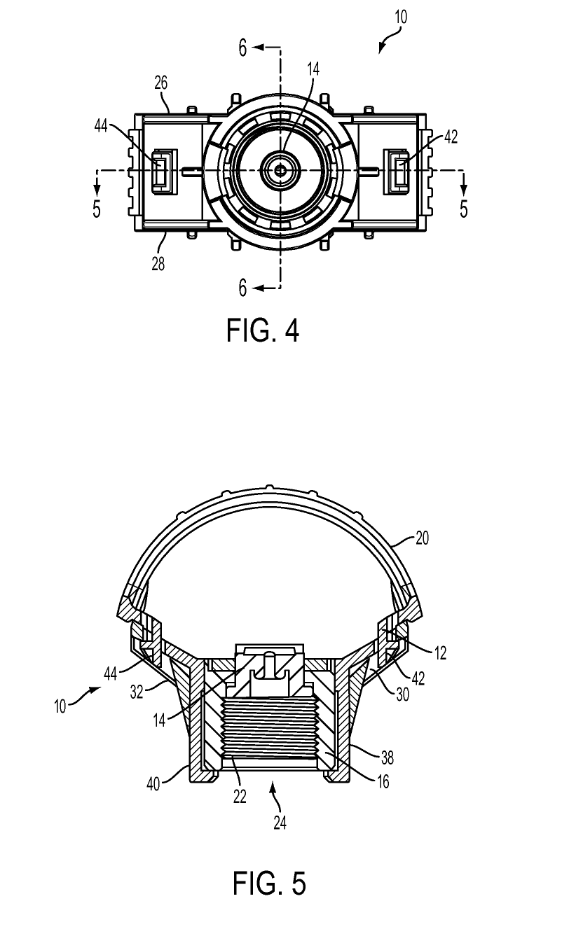

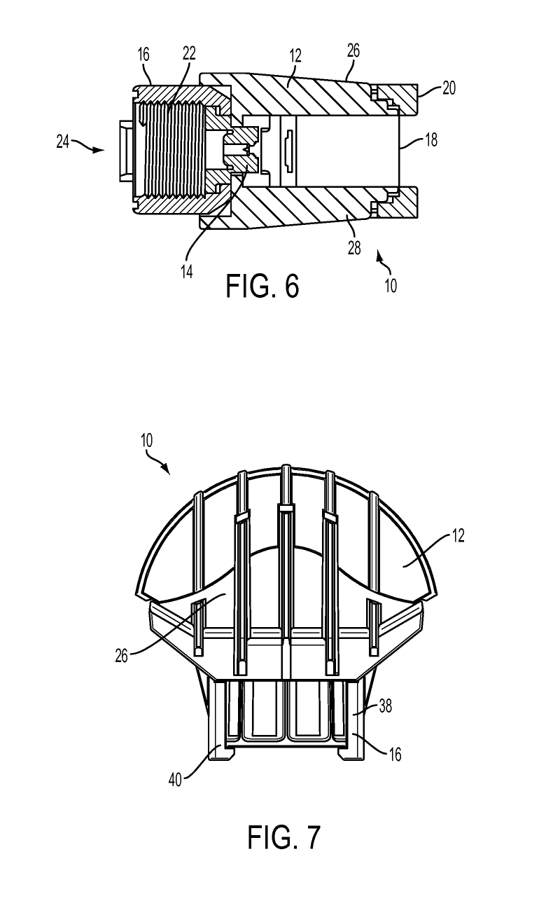

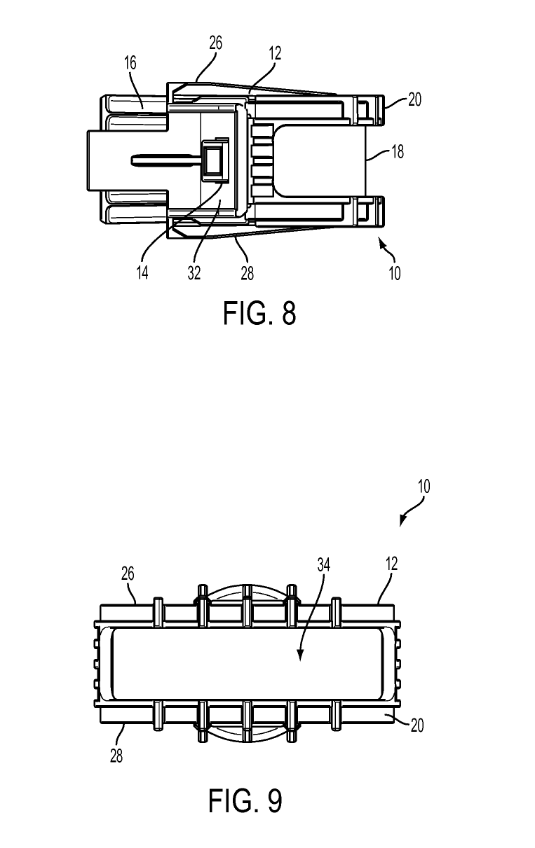

Referring now to the drawings, in which like reference numerals refer to like parts throughout, there is seen in FIG. 1 a foaming nozzle, designated generally by reference numeral 10, for use with a conventional sprayer (not shown) used to spray pesticide, herbicide, pesticide, and the like. Foaming nozzle 10 comprises a foaming head 12, a spray nozzle 14 that is adapted to be seated in the rear portion of head 12, a cap nut 16 that is connected to the rear end of head 12 and engages and secures spray nozzle 14 in position, a mesh screen 18 that is attached to the front end of head 12, and a foaming screen retainer 20 that is attached to head 12 and secures mesh screen 18 in position. Cap nut 16 includes internal threading 22 that permit its connection to the external threads formed on a sprayer (not shown) and a passageway 24 which creates a fluid communication pathway between the sprayer and nozzle 14. Spray nozzle 14 is adapted to securely sit within cap nut 16 and be sandwiched between cap nut 16 and head 12, and in fluid communication with the liquid in the sprayer via passageway 24. In use, liquid sprayed from a sprayer would be forced through passageway 24 and through nozzle 14 which would then accelerate the liquid towards mesh screen 18. The liquid passing through mesh screen 18 causes it to foam.

Head 12 comprises an upper plate 26, a lower plate 28 held in spaced, parallel relation to upper plate 26 by sidewalls 30, 32 that are positioned on opposite sides of plates 26 and 28 to define an open front end 34 and open rear end 36. The leading edges of top and bottom plates 26 and 28 are curved inwardly, thereby defining the shape of open front end 34 accordingly. A pair of flanged arms 38 and 40 is integrally formed with head and each extends rearwardly from between top and bottom plates 26 and 28 to define an engagement mechanism for cap nut 16 which extends between arms 38 and 40 and is snappingly engaged by the flanged ends of the arms.

Mesh screen 18 and screen retainer 20 are each curved in contoured relation to the curvature of the leading edges of top and bottom plates 26 and 28. In assembling nozzle 10, mesh screen 18 is positioned over curved open front end 34 with ridges formed around the periphery of the top and bottom plates serving as stops for the screen. Screen retainer 20 may then be attached to head 12 sandwiching the mesh screen 18 between itself and head 12. More specifically, sidewalls 30 and 32 each include an opening formed therethrough which provide part of the attachment means for foaming screen retainer 20. Screen retainer 20 includes rearwardly extending clasps 42 and 44 that pass through and interlock with the openings formed through the sidewalls 30 and 32 to securely interconnect the retainer 20 to the head 12.

What is claimed is:

1. A nozzle assembly for use with a sprayer container containing a liquid, comprising:
a. a nozzle head having a body that defines an open front end that curves along a predetermined radius;
b. a mesh screen attached in covering relation to said open front end and extending along said predetermined radius; and
c. a nozzle adapted to direct the liquid towards said mesh screen in a direction that is normal to said predetermined radius.

2. The nozzle assembly according to claim 1, further comprising a screen retainer that interconnects said mesh screen to said nozzle head.

3. The nozzle assembly according to claim 1, further comprising a nut for interconnecting the nozzle assembly to the sprayer.

4. The nozzle assembly according to claim 1, wherein said nozzle is adapted to disperse the liquid across a range of 50°-100°.

5. The nozzle assembly according to claim 1, wherein said nozzle is spaced from said mesh screen at a distance between 0.90″ and 1.10″.

6. A nozzle for use with a sprayer container containing a liquid, comprising:
a. a nozzle body having a rear end adapted for interconnection to the sprayer container and a front end that curves along a predetermined radius; and
b. a mesh screen attached to said nozzle body and positioned within said front end and along said predetermined radius.

7. The nozzle according to claim 6, further comprising a nozzle adapted to direct the liquid towards said mesh screen in a direction that is normal to said predetermined radius.

8. The nozzle according to claim 7, wherein said nozzle is adapted to disperse the liquid across a range of 50°-100°.

9. The nozzle according to claim 7, wherein said nozzle is spaced from said mesh screen at a distance between 0.90″ and 1.10″.

10. The nozzle according to claim 6, further comprising a screen retainer that interconnects said mesh screen to said nozzle head.

11. The nozzle according to claim 6, further comprising a nut for interconnecting the nozzle to the sprayer.

12. The nozzle according to claim 7, wherein said nozzle is adapted to disperse the liquid across a range of 50°-100°.
